(19) United States
(12) Patent Application Publication
(10) Pub. No.: US 2008/0014328 A1
(43) Pub. Date: Jan. 17, 2008

(54) Coffee filled packet

(76) Inventors: Richard Edward Gillenwater, South Charleston, WV (US); Lisa Ann Gillenwater, South Charleston, WV (US)

Correspondence Address: Galasso & Associates, LP, P.O. Box 26503, Austin, TX, 78755-0503, US

(21) Appl. No.: 11/487,642

(22) Filed: Jul. 17, 2006

(51) Int. Cl. A23F 5/00

(52) U.S. Cl. 426/594

(57) ABSTRACT

Coffee bean particles placed in a water permeable packet sized to fit between a cheek and gum is disclosed. Such a product can overcome many difficulties for those who consume coffee. For example, if an individual is away from civilization or simply does not have hot water or a coffee maker and has a desire to consume coffee, the individual can place the packet into ones mouth and enjoy coffee as if drinking a cup of coffee.

### FIELD OF THE DISCLOSURE

The present disclosure is generally related to cup-less coffee consumption and to a packet filled with soluble coffee bean particles that facilitates such coffee consumption.

### BACKGROUND

The beverage known as coffee has a long history. Coffee beans have been traded as a commodity between civilizations for many years due to coffee's pleasing aroma and stimulating effect on humans. Preparing a cup of coffee for consumption is not an efficient process and requires many resources. For example, preparing a cup of coffee requires tools such as a grinder, to grind coffee beans and some form of strainer or filter to extract soluble coffee from the ground coffee bean, a coffee brewer or some way to heat water, a coffee pot to contain the coffee, a coffee cup, and of course, a source of water. Brewing a pot of coffee and even brewing a cup of coffee takes time and to make an excellent cup of coffee, proper proportions of coffee, water and heat must be utilized. Thus, when someone who desires to consume coffee is not near a heat source and a water source or does not have a cup, they will be unable to satisfy their craving. Accordingly, there is a need for an improved system and method for enjoying coffee without the hassles normally associated with preparing a cup of coffee.

### BRIEF DESCRIPTION OF THE DRAWINGS

FIG. 1 is a top view of a cup-less coffee packet;

FIG. 2 is a side view of a cup-less coffee packet; and

FIG. 3 is a side view of a human head with a cup-less coffee packet inserted in the human's mouth.

### DETAILED DESCRIPTION OF THE DRAWINGS

The following is a detailed description of novel embodiments depicted in the accompanying drawings. The embodiments are in such detail as to clearly communicate the subject matter. However, the amount of detail offered is not intended to limit anticipated variations of the described embodiments, but on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

Generally, methods and arrangements for cup-less coffee consumption are provided herein. While specific embodiments will be described below with reference to particular configuration, those of skill in the art will realize that embodiments may advantageously be implemented with other configurations.

A new product that includes coffee in a water permeable packet that is sized to fit between a cheek and gum is disclosed. Such a product can overcome many difficulties for those who consume coffee. For example, if an individual is away from civilization or simply does not have hot water or a coffee maker and has a desire to consume coffee, the individual can place the packet into ones mouth and enjoy coffee as if drinking a cup of coffee.

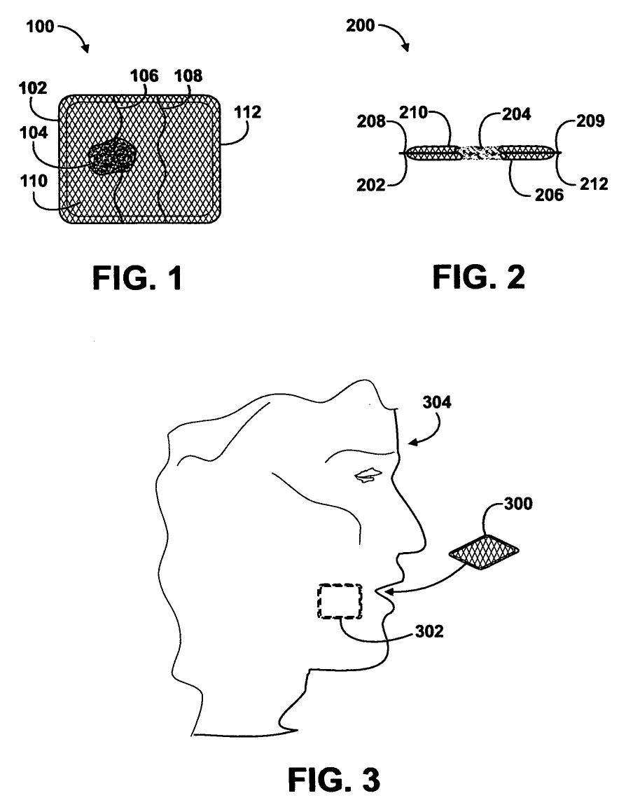

Referring to FIG. 1 a coffee packet 100 is provided. The coffee packet 100 can include a single piece membrane material 110 such as a piece of filter paper folded to surround coffee bean particles 104. The folds can form edges 112 of the packet 100. Ground or freeze dried coffee bean particles 104 can be enclosed by the membrane material 1 10 such that the membrane 1 10 can prevent the escape of the coffee bean particles 104 when the packet 100 is placed in a mouth of the user. Thus, the user can enjoy coffee in a cup-less manner without having insoluble coffee particle circulating in the user's mouth and getting caught between the teeth of the user.

The membrane material 110 can be a water permeable membrane that surrounds the coffee bean particles 104. The size of the packet 100 can be adapted to fit in a human mouth between a cheek and gum. In one embodiment the sealable edge 102 can seal the coffee bean particles 104 within the membrane 110 such that insoluble coffee bean particles can be substantially contained within the water permeable membrane 110 in the presence of fluids. When the packet 110 is placed in the mouth between the cheek and gum, fluids within the mouth can circulate into and out of the membrane 1 10 thereby extracting juices containing soluble coffee from the packet 100.

When the packet 100 is packaged for sale, it can be packaged in an air tight envelope (not shown) to seal the coffee bean particles 104 from environmental elements such as oxygen and moisture. The envelope may enclose a plurality of packets 100 and may have a re-sealable closure such that after removal of a single packet the remaining packets can be sealed from the elements.

In one embodiment, the packet 100 can have baffles 106 and 108 to restrict movement of the coffee bean particles 104 within the packet 100. For example, during shipping or during the coffee extraction process when the packet 100 is a user's mouth, the coffee particles may shift making the packet 100 non-uniform in shape. It may be desirable to keep the thickness of the packet 100 somewhat uniform such that it fits more comfortably between the cheek and gum of the user. In another embodiment, the membrane 110 can be somewhat rigid such that the movement of the coffee is limited by such rigidity.

In another embodiment, the sealable edge 102 can have thermo-plastic film such that a heat stamping process can seal the edges of the packet 100. Finely ground coffee bean particles have some soluble material and some insoluble material and the permeable membrane 110 can have porosity such that at least a majority of insoluble coffee bean material cannot penetrate the membrane 110. Thus, the porosity or size of holes in the membrane 110 can be sized smaller than the majority of the insoluble coffee bean particles 104.

For example, the coffee bean particles 104 can be ground and screened to yield particles generally, on the average, in excess of 420 microns and the membrane 110 can have holes that on the average are less than 400 microns in diameter to reduce the amount of insoluble coffee material that can escape from the confines of the membrane 110 and “float” about the mouth of the user. The packet 100 can be sized and manufactured such that it fits in a user's mouth and no seams will rub against and irritate the inside of the user's cheek and the user's gum. In one embodiment, the packet 100 measures less than inch and a quarter long, by three quarters of an inch wide, by five eights of an inch thick.

Different additives can be added to the packet 100 including any aroma such as chocolate aroma, a coffee aroma, an aroma enhancer, a cherry flavor, a vanilla flavor, a cream flavor, or a sugar flavor. Other tasteless products such as a nicotine supplement, a diet aide and an appetite suppressant could also be added to the coffee bean particles 104 or to the packet 100. Additionally, additives could also be added to retard the extraction rate of different elements of the additives and the soluble coffee material to enhance the flavor during the fluid/coffee extraction process.

Referring to FIG. 2 a side view of a coffee packet 200 is illustrated. As illustrated, the coffee packet 200 can be shaped such it has a substantially uniform thickness and no seams are present on the flat surfaces of the packet 200 that may rub on, and irritate the inside of the user's mouth. Referring briefly to FIG. 3, the insertion of a coffee packet 300 into the mouth of a user 304 is illustrated. The phantom coffee packet 302 is illustrated between the cheek and gum of the user 304. Digestive fluids from the mouth of the user can facilitate extraction of coffee from the packet 300.

Referring back to FIG. 2, the coffee pack 200 can sealably enclose ground coffee or instant coffee or a mix thereof referred to collectively as coffee based material 204 herein. The packet 200 can include a first porous membrane 210 having edges such as edges 208 and 209 and second porous member 206 having edges 202 and 212. The second membrane 206 can be superimposed on the first membrane 210 such that the edges of the first membrane 208 and 209 are sealed with the second membrane edges 202 and 212 to contain the coffee material 204. The pack 200 can be sized such that it comfortably fits between the cheek and gum of the user. The packet 200 can be less than three sixteenths of an inch in thickness such that a large bulge does not appear in the user's cheek when the packet 200 is retained in the user's mouth. The packet 200 can also be seamless on its sides such that seems do not come into direct contact with and rub on the cheek and gum of the user.

The first membrane 210 and the second membrane 206 can contain insoluble ground coffee and prevent the insoluble ground coffee from exiting the pack 200 when the packet 200 is between a cheek and gum. The first and second membranes 210 and 206 can be a filter paper or some other water permeable membrane such as the material utilized in tea bags. The edges 202, 208, 208 and 212 could have a thermally activated adhesion material such that during manufacture of the packet a heat stamping process could be utilized to secure the first membrane 210 to the second membrane 206. In one embodiment, the sealable edge could be made by providing a coating on one side of the first and second membrane 206 and 210 such that the membrane coating becomes adhesive upon a heat sealing operation. In another embodiment, baffles could be placed between the first membrane and the second membrane to minimizing the movement of the coffee bean particles 204 within the packet.

The coffee packet 200 could also be manufacture by cutting a first piece of filter paper and forming the filter paper to surround the coffee material 204 such that the formed filer paper will fit in an area between a human jaw and a human cheek. The edges of the filter paper can be sealed to retain the coffee material 204. The sealing edge can form a continuous uniform edge in a single plane such that no seams will rub against a user's cheek or gum. The manufacturing can further include cutting a second piece of filter paper and sandwiching the coffee material 204 between the first piece of filter paper and the second piece of filter paper.

When roasted and ground coffee material 204 is utilized, very fine particles can be removed from the material in order to reduce the amount of insoluble grains of the coffee bean that can escape the water permeable membrane and circulate in the mouth of the user. Screening or pelatizing the ground and roasted coffee may be performed to reduce the amount of insoluble coffee material that may pass through the water permeable membrane.

A single variety of coffee could be utilized and also a blend of different coffees could be utilized in the packet 200. Producing a flavorful packet can consist of more than the amount of coffee placed in the packet 200. Soluble coffee solids are comprised of multiple compositions that do not extract themselves from the coffee solids at the same rate. For example, the digestive acids in saliva extract chemical components at different rates than pure water. Each of these compositions contributes to the production of the taste. Thus, agents can be added to make the extractions occur at desirable rates.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An apparatus for cup-less coffee consumption comprising:
coffee bean particles;
a water permeable membrane adapted to surround the coffee bean particles, the membrane adapted to fit in a human mouth between a cheek and gum of the human; and
a sealable edge coupled to the water permeable membrane such that the coffee bean particles can be substantially contained within the water permeable membrane between the cheek an gum thereby allowing digestive fluids within the mouth of the human to pass into and out of the water permeable membrane to extract coffee from the coffee bean particles utilizing digestive fluids.

2. The apparatus of claim 1 further comprising an air tight envelope surrounding the water permeable membrane to seal the coffee from environmental elements prior to usage of the apparatus.

3. The apparatus of claim 1 further comprising a baffle coupled to the water permeable membrane to restrict movement of the coffee bean particles within the water permeable membrane.

4. The apparatus of claim 1 wherein the sealable edge comprises a thermo-plastic.

5. The apparatus of claim 1 wherein the coffee bean particles comprises freeze dried coffee particles.

6. The apparatus of claim 1 wherein the coffee bean particles comprise insoluble particles and the permeable membranes has porosity such that at least a majority of insoluble particles cannot penetrate the membrane.

7. The apparatus of claim 1 wherein the coffee bean particles are screened to reduce the amount of insoluble coffee material that can permeate the water permeable membrane.

8. The apparatus of claim 1 wherein the water permeable membrane measures less than inch and a quarter long, by a three quarters of an inch wide by five eights of an inch thick.

9. The apparatus of claim 1 wherein the coffee bean particles further comprise one of an aroma enhancer, a cherry flavor, a vanilla flavor, a cream flavor, a sugar flavor, nicotine supplement, a diet aide and an appetite suppressant.

10. The apparatus of claim 1 further comprising a first flat surface and a second flat surface on the water permeable membrane wherein the first and second flat surface are seamless.

11. A method of manufacture comprising:
cutting a first piece of filter paper;
forming the filter paper to surround coffee material such that the filer paper is less than one inch long by three quarters of an inch wide by seven sixteenths of an inch wide such that the formed filter paper will fit in an area between a human jaw and a human cheek; and
sealing edges of the filter paper to retain the coffee material.

12. The method of claim 11 wherein the sealing edge is a continuous edge.

13. The method of claim 11 further comprising cutting a second piece of filter paper and sandwiching the coffee material between the first piece of filter paper and the second piece of filter paper.

14. The method of claim 11 further comprising adding a flavoring to the coffee material.

15. The method of claim 11 further comprising adding one of an appetite suppressant, a diet aid and nicotine to the coffee material.

16. A pack for providing coffee to a user comprising:
ground coffee beans;
a first porous membrane having edges;
a second porous membrane having edges, the second membrane superimposed on the first membrane such that the edges of the first membrane are sealed with the edges of the second membrane to contain the ground coffee beans, wherein the pack is less than three sixteenths of an inch thick, and the first porous membrane and the second porous membrane are seamless and restrict insoluble ground coffee from permeating the first and second membrane, wherein the pack fits between a cheek and gum without exposing seams to the cheek and gum.

17. The pack of claim 16 wherein the water permeable membrane comprises filter paper.

18. The pack of claim 16 wherein the sealable edge comprises a thermally activated adhesion.

19. The pack of claim 16 wherein the edges further comprise a coating on one side of the first and second membrane such that the edges become adhesive upon a heat sealing operation.

20. The pack of claim 16 further comprising baffles disposed between the first membrane and the second membrane.
